(19) United States
(12) Patent Application Publication
(10) Pub. No.: US 2005/0109858 A1
(43) Pub. Date: May 26, 2005

(54) Administration form for oral administration of active ingredients, vitamins and/or nutrients

(76) Inventor: Rasoul Sedaghat Kerdar, Aachen (DE)

Correspondence Address: Geza C. Ziegler, Jr.;PERMAN & GREEN, LLP, 425 Post Road, Fairfield, CT, 06824, US

(21) Appl. No.: 10/951,243

(22) Filed: Sep. 27, 2004

Related U.S. Application Data
(63) Continuation of application No. PCT/EP03/03133, filed on Mar. 26, 2003.

(30) Foreign Application Priority Data
Mar. 27, 2002 (DE) 102 13 773.0
Jun. 24, 2002 (DE) 102 28 175.0

(51) Int. Cl. A61J 15/00

(52) U.S. Cl. 239/33

(57) ABSTRACT

The invention relates to an administration form for oral administration of active ingredients, vitamins and/or nutrients, comprising a straw with a sealing device in the form of a straw part which can be bent in a reversible manner between the formulation and the opening of the straw providing free access to said formulation. When said part is bent, the formulation is prevented from exiting from said straw. The invention also relates to a kit consisting of the administration form and a transport liquid, and to a method for the production of said administration form.

The invention relates to a form of administration for oral administration of active ingredients, vitamins and/or nutrients, comprising a drinking straw with a part of the drinking straw which can be reversibly bent between the formulation and a drinking straw opening as a closure device, so exiting of the formulation from the drinking straw is prevented in the bent position, to a kit consisting of the form of administration and a conveying liquid and to a method for producing the form of administration.

The administration of active ingredients, vitamins and/or nutrients with the aid of a drinking straw, which contains an active ingredient, vitamin and/or nutrient formulation which can be transported by a liquid, is known. Patients who have difficulties in or have an aversion to taking capsules or tablets are offered a further form of administration of active ingredients, vitamins and/or nutrients.

The drinking straws described in the prior art for oral administration of active ingredients, vitamins and/or nutrients comprise stoppers or caps as the closure device for keeping back the active ingredient, vitamin and/or nutrient formulation located in the drinking straw. The stoppers or caps have to be removed before the drinking straw is used. There is the risk during removal of these known closure devices of spillage of the active ingredient, vitamin and/or nutrient formulation.

The object is therefore posed of providing a form of administration for oral administration of active ingredients, vitamins and/or nutrients comprising a drinking straw with a closure device, which is optimally simple to produce and does not have the drawbacks of the forms of administration described in the prior art.

The object is achieved according to the invention by the provision of a form of administration for oral administration of active ingredients, vitamins and/or nutrients comprising a drinking straw which has two openings and contains a blocking device impermeable for an active ingredient, vitamin and/or nutrient formulation but permeable for air and a conveying liquid, and comprising a closure device impermeable for the active ingredient, vitamin and/or nutrient formulation, the active ingredient, vitamin and/or nutrient formulation located in the drinking straw being arranged between blocking device and closure device, characterised in that the closure device consists of a part of the drinking straw which can be reversibly bent between the formulation and between the drinking straw opening freely accessible for the formulation, so exiting of the formulation from the drinking straw is prevented in the bent position.

This drinking straw opening is the opening from which the formulation is removed with the aid of the conveying liquid, i.e. the opening on the side remote from the blocking device.

The part of the drinking straw which can be bent can be reversibly fixed in the bent position with the aid of a ring, a clip, a sleeve or a tube.

The active ingredient, vitamin and/or nutrient formulation is preferably solid or highly viscous. A multi-particulate active ingredient, vitamin and/or nutrient formulation is preferred, wherein the particles of the multi-particulate formulation preferably have a diameter or 50 to 1,500 μm.

The active ingredients, vitamins and/or nutrients alone or the active ingredient, vitamin and/or nutrient formulations as a whole can be insoluble or at least partially soluble in the conveying liquid.

If the active ingredients, vitamins or nutrients or the formulations thereof are soluble in the conveying liquid, they are dissolved by the conveying liquid flowing past and entrained in dissolved form. If the active ingredients, vitamins or nutrients or the formulations thereof are insoluble in the conveying liquid, on the other hand, they are suspended in the conveying liquid flowing past and entrained in the suspended form by the conveying liquid. Multi-particulate formulations are preferably used for this. The particles should be so small and light that they can be conveyed by the conveying liquid. The adhesion of the particles to each other or to the walls of the drinking straw should be as low as possible, and this can optionally be achieved by a suitable surface treatment of the particles.

All orally administrable substances in the form of a suitable formulation can be used as the active ingredients, preferably therapeutic active ingredients, vitamins and nutrients. The drinking straw preferably contains a precisely determined dose of these substances.

The blocking device is preferably a stopper, of which the cross-section is preferably adapted to the cross-section of the drinking straw.

On the one hand, the stopper can be fixed in the drinking straw, wherein the stopper is preferably fixed owing to constrictions of the drinking straw, or is glued into the drinking straw.

On the other hand, the stopper can also be moved between two stops. The drinking straw is constricted as a result of the stops, the constrictions being configured in such a way that the stopper, but not the formulation particles insoluble in the conveying liquid, is kept back thereby.

The stopper preferably consists of filter material, more preferably of non-woven material or press-compacted fibrous material.

A membrane fixed in the drinking straw is also preferred as the blocking device, the cross-section of the membrane preferably being adapted to the cross-section of the drinking straw and the membrane preferably being glued to the drinking straw. The membrane preferably consists of synthetic material.

A grid fixed in the drinking straw, of which the mesh diameter is smaller than the diameter of the smallest formulation particle, is also preferred as the blocking device. The cross-section of the grid is preferably adapted to the cross-section of the drinking straw and the grid is preferably fixed in the drinking straw by constrictions thereof or is glued into the drinking straw. The grid preferably consists of synthetic material.

A constriction of the drinking straw which is configured in such a way that even the smallest formulation particles are held back thereby is also suitable as the blocking device. The flow of the conveying liquid must not be reduced by the blocking device to the extent that a solid, insoluble active ingredient, vitamin and/or nutrient formulation can no longer be entrained.

The drinking straw is flexible at least in the region in which it can be reversibly bent.

The drinking straw preferably consists of a synthetic material. At least the region in which the drinking straw can be reversibly bent is preferably constructed from a resilient synthetic material or a synthetic material which can be plastically deformed at a temperature below its softening point. The region in which the drinking straw can be reversibly bent is preferably configured in the manner of a concertina.

The internal diameter of the drinking straw should preferably be at least 3 mm, so a sufficient quantity of conveying liquid can be sucked through the drinking straw in order to convey the formulation. An internal diameter of 4 to 15 mm is preferred, a diameter of 5 to 10 mm most particularly preferred.

The drinking straw preferably has a round, oval, rectangular or square cross-section and preferably has a smooth inner side.

The drinking straw opening, which is freely accessible for the formulation, is preferably constructed as a mouth piece, in particular preferably ribbed, while the drinking straw opening which faces the blocking device is preferably configured as a connecting piece to a conveying liquid reservoir. The drinking straw preferably comprises a marking for indicating the mouthpiece and/or to indicate the suction direction of the conveying liquid. Handling is facilitated by this identification.

At least the part of the drinking straw containing the formulation is transparent and/or coloured. When using a transparent drinking straw, the take-up of active ingredient, vitamin and/or nutrient formulation can be observed, while the use of an opaquely coloured drinking straw provides the possibility of concealing the administration of an active ingredient, vitamin and/or nutrient formulation.

The invention also relates to a kit consisting of the form of administration according to the invention and a physiologically safe conveying liquid containing active ingredients, nutrients and/or vitamins.

Preferably an aqueous liquid is suitable as the conveying liquid, water, lemonade, fruit juice without fruit pulp, tea or coffee being most particularly preferred.

The invention also relates to a method for producing the form of administration in which the blocking device is introduced into the drinking straw, the formulation introduced through one drinking straw opening into the drinking straw and the drinking straw is bent between the formulation and the drinking straw opening freely accessible for the formulation, i.e. the drinking straw opening facing the formulation.

The invention also relates to a method for producing the form of administration in which the drinking straw is bent and the formulation and the blocking device are introduced into the drinking straw one after the other through the accessible drinking straw opening.

A method for producing the form of administration according to the invention is preferred in which the part of the drinking straw which can be bent is reversibly fixed in the bent position with the aid of a ring, a clip, a sleeve or a tube.

The following figures show exemplary embodiments of the forms of administration according to the invention. The inventive idea is in no way limited hereby.

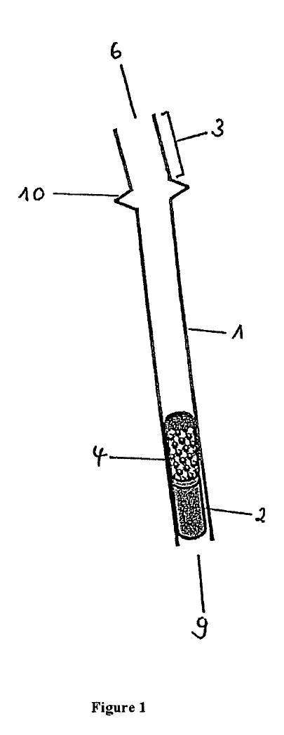

FIG. 1 shows a form of administration according to the invention in a side view.

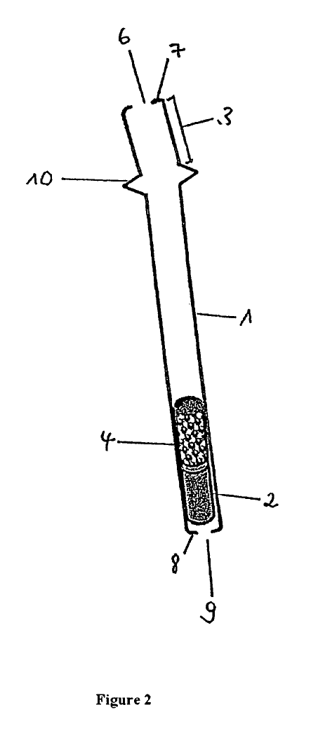

FIG. 2 shows a further form of administration according to the invention in a side view.

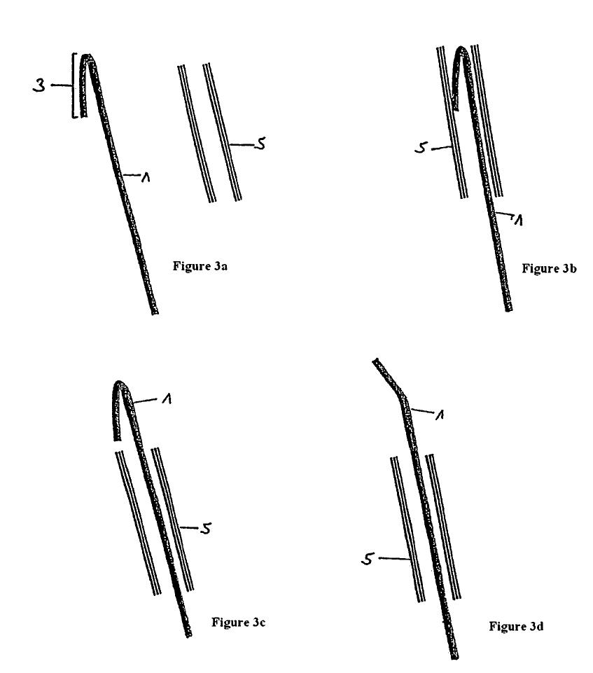

FIG. 3a to 3d show a form of administration according to the invention with a tube which is open on both sides, for reversibly fixing the part of the drinking straw which can be reversibly bent before, during and after use.

The form of administration shown in FIG. 1 comprises a drinking straw (1) which has two openings (6, 9) and a stopper fixed in the drinking straw as the blocking device (2), a part which can be reversibly bent as a closure device (3) and a formulation (4) located between the blocking device and the closure device in the straw.

The drinking straw (1) has a round-cross section and is straight.

The stopper (2) consists of filter material and is permeable to air and conveying liquid but impermeable for the formulation. The stopper is cylindrical and has a round-cross section, the diameter of the stopper being adapted to the internal diameter of the drinking straw. The stopper is glued into the drinking straw.

The formulation (4) exists in the form of spherical particles.

The region (10) in which the drinking straw (1) can be reversibly bent is configured in the manner of a concertina.

The form of administration shown in FIG. 2 substantially corresponds to the form of administration shown in FIG. 1. However, instead of a fixed stopper a stopper which can be moved between two stops (7, 8) is used as the blocking device (2).

The diameter of the largest formulation particles is smaller than the internal diameter of the drinking straw at the point of the stop (7), so the formulation particles can pass this point.

The form of administration shown in FIGS. 3a to 3d comprises a drinking straw (1) with a part (3) which can be reversibly bent. The bent position can be reversibly fixed with the aid of a tube (5) open on both sides. For this purpose, the drinking straw (1) is introduced into the tube (5) in the bent position. Prior to use, the tube (5) is displaced to such an extent that the reversibly bent part (3) of the drinking straw (1) is exposed and the part (3) of the drinking straw (1) which can be reversibly bent can be adjusted as desired.

The internal diameter of the tube (5) is matched to the spatial requirement of the drinking straw (1) in the bent position. The length of the tube (5) is smaller than the length of the drinking straw (1) in the bent position.

1. Form of administration for oral administration of active ingredients, vitamins and/or nutrients, comprising a drinking straw (1) which has two openings (6, 9) and which contains a blocking device (2) which is impermeable for an active ingredient, vitamin and/or nutrient formulation but is permeable to air and a conveying liquid, and comprises a closure device (3) impermeable for the active ingredient, vitamin and/or nutrient formulation, the active ingredient, vitamin and/or nutrient formulation (4) being arranged between the blocking device and the closure device in the drinking straw, characterised in that the closure device (3) comprises a part (3) of the drinking straw which can be reversibly bent between the formulation (4) and the drinking straw opening (6) freely accessible for the formulation, so exiting of the formulation from the drinking straw is prevented.

2. Form of administration according to claim 1, characterised in that the bendable part (3) of the straw (1) can be reversibly fixed in the bent position with the aid of a ring, a clip, a sleeve or a tube (5).

3. Form of administration according to claim 1, characterised in that the active ingredient, vitamin and/or nutrient formulation (4) is solid.

4. Form of administration according to either claim 1, characterised in that the active ingredient, vitamin and/or nutrient formulation (4) is highly viscous.

5. Form of administration according to claim 1, characterised in that the active ingredient, vitamin and/or nutrient formulation (4) is multi-particulate.

6. Form of administration according to claim 1, characterised in that the active ingredient, vitamin and/or nutrient formulation (4) is insoluble in the conveying liquid.

7. Form of administration according to claim 1, characterised in that the active ingredient, vitamin and/or nutrient formulation (4) is at least partially soluble in the conveying liquid.

8. Form of administration according to claim 1, characterised in that the blocking device (2) is a stopper.

9. Form of administration according to claim 8, characterised in that the stopper (2) can be moved between two stops (7, 8).

10. Form of administration according to claim 8, characterised in that the stopper (2) is fixed.

11. Form of administration according to claim 1, characterised in that the blocking device (2) is a membrane fixed in the drinking straw.

12. Form of administration according to claim 5, characterised in that the blocking device (2) is a grid fixed in the drinking straw, of which the mesh diameter is less than the smallest diameter of the formulation particles (4).

13. Form of administration according to claim 5, characterised in that the blocking device (2) consists of a constriction of the drinking straw, so the cross-section of the drinking straw is narrower than the smallest diameter of the formulation particles (4).

14. Form of administration according to claim 1, characterised in that at least the region (10) in which the drinking straw (1) can be reversibly bent is flexible.

15. Form of administration according to claim 1, characterised in that the drinking straw (1) consists of a synthetic material.

16. Form of administration according to claim 15, characterised in that at least the region (10) in which the drinking straw (1) can be reversibly bent is constructed from a resilient, synthetic material.

17. Form of administration according to claim 15, characterised in that at least the region (10) in which the drinking straw (1) can be reversibly bent is constructed from a synthetic material plastically deformable at a temperature below its softening point.

18. Form of administration according to claim 16, characterised in that at least the region (10) in which the drinking straw (1) is reversibly bent is configured in the manner of a concertina.

19. Kit consisting of the form of administration according to claim 1 and a physiologically safe conveying liquid optionally containing active ingredients, nutrients and/or vitamins.

20. Kit according to claim 19, characterised in that the conveying liquid is an aqueous liquid.

21. Kit according to claim 19, characterised in that the conveying liquid is water, lemonade, fruit juice without fruit pulp, tea or coffee.

22. Method for producing a form of administration according to claim 1, characterised in that the blocking device (2) is introduced in to the drinking straw (1), the formulation (4) is introduced through one drinking straw opening (6) into the drinking straw (1) and the drinking straw (1) is bent between the formulation (4) and the drinking straw opening (6).

23. Method for producing a form of administration according to claim 1, characterised in that the drinking straw (1) is bent and the formulation (4) and the blocking device (2) are introduced one after the other through the drinking straw opening (9) into the drinking straw.

24. Method for producing a form of administration according to claim 22, characterised in that the part (3) of the drinking straw which can be bent is reversibly fixed in the bent position with the aid of a ring, a clip, a sleeve or a tube (5).
